(19) United States
(12) Patent Application Publication
(10) Pub. No.: US 2004/0264943 A1
(43) Pub. Date: Dec. 30, 2004

(54) DVD player system with FM stereo transmitter for auto audio

(76) Inventor: Hong-Xi Chen, Los Angeles, CA (US)

Correspondence Address: Raymond Y. Chan, 108 N. Ynez Ave., Suite 128, Monterey Park, CA, 91754, US

(21) Appl. No.: 10/609,441

(22) Filed: Jun. 30, 2003

(51) Int. Cl. H04N 5/781

(52) U.S. Cl. 386/125; 386/126

(57) ABSTRACT

A DVD player system, for an auto audio system which comprises at least a speaker having an audio input, includes a DVD loader for reading storing data stored in a DVD and converting the storing data into a digital audio data and a digital video data, a video display unit electrically connected with the DVD loader to convert the video data into a video signal, and a wireless audio system. The wireless audio system includes an audio signal transmitter electrically connected to the DVD loader to transmit the audio data as an audio frequency signal, and an audio signal receiver, which is adapted for electrically connecting with the audio input of the speaker, wirelessly communicating with the audio signal transmitter for receiving the audio frequency signal therefrom in a wireless manner. Therefore, the audio frequency signal is then converted into an acoustical signal through the speaker.

### BACKGROUND OF THE PRESENT INVENTION

1. Field of Invention

The present invention relates to an auto audio system, and more particularly to a Digital Video Disc (DVD) player system for the auto audio system, wherein an audio signal loaded from the DVD loader is wirelessly transmitted to the speaker so as to avoid clumsy wire connection between DVD loader and the speaker.

2. Description of Related Arts

Generating sound by electrical or electronic means is not new. A conventional audio system, such as that employed in a conventional video system, generally comprises an audio signal generator for generating digital or analog audio signals and at least one loud speaker electrically connected thereto via a cable in such a manner that the audio signal generated by the audio signal generator is transmitted through the cable to produce a predetermined pattern of sound wave of audible frequency for sound production.

Such audio system is widely used throughout the world. Their prices also vary, ranging from tens of dollars to thousands of dollars. The difference in selling price may be justified by their differing quality of sound produced. However, such audio systems share one common practical difficulty, namely, inevitably utilization of tangible cable for audio signal transmission. In fact, the quality of sound which is eventually generated by the conventional audio system depends to a considerable extent the quality of the cable which is utilized. Then, it is nothing to surprise that some of the cables are expensive as well.

The conventional audio system actually works well in some circumstances. But for those large and confined areas, the practical difficulty of cable wiring becomes apparent. For larger areas, such as in a big house, where the loud speaker may be distant away from the audio signal generator, very long cables may be needed for the audio system to work properly. In such circumstance, as mentioned earlier, price for purchasing expensive cables may pose a problem, but even though price is not a significant problem for the house's owner, the difficulty in hiding such very long cable either for the sake of ensuring that it will not interfere with other appliances or simply for aesthetical purpose is certainly pressing for the house's owner.

Furthermore, as mentioned earlier, the difficulty is not exclusive for big houses. For example, in a confined area such as a car, proper positioning of the cable may pose difficulty as well. Very often, the car's owner may choose to install a mini HI-FI or a DVD player to his/her car. However, with the need for handling the cable in mind, the owner may find it difficult for him/her to properly install them because it is too demanding for him/her to handle the cable in the confined space where complicated electronic circuitry or electrical appliances have already been installed. As a result, when the owner wants to install an audio or a video system into his/her car, he may simply resort to professional technicians. This eventually raises the cost of installation and more importantly, brings inconvenience to the owner because he/she must leave the car in a specific site where installation takes place. In worse, depending on the proficiency of the technicians appointed, the installation process may take up to few days or a week, which means that the owner cannot drive that car in that period.

### SUMMARY OF THE PRESENT INVENTION

A main object of the present invention is to provide a Digital Video Disc (DVD) player system for an auto audio system, wherein an audio signal is wirelessly transmitted between the DVD loader and the speaker so as to avoid such clumsy wire connection therebetween.

Another object of the present invention is to provide a DVD player system for auto audio system, wherein the audio signal through radio frequency so as to enhance the stability of the wireless connection between the DVD loader and the speaker.

Another object of the present invention is to provide a DVD player system for auto audio system, wherein the audio signal is transmitted wirelessly without deteriorating the quality of the signal transmitted.

Another object of the present invention is to provide a DVD player system for auto audio system, which utilizes wireless audio signal transmission to remove the difficulty in handling conventional clumsy audio signal cable while installing the audio system. In other words, the present invention is easy to install.

Another object of the present invention is to provide a DVD player system for auto audio system, wherein the audio signal is adapted to be wirelessly transmitted in a wide range of surrounding circumstances which are also present for conventional audio systems, such as in a big house or inside a car. In other words, the wireless transmission will not be substantially blocked by typical environmental factors.

Another object of the present invention is to provide a DVD player system with an audio system, which does not involve any complicated mechanical or electrical components which affect the structure and operation of the DVD player so as to minimize the manufacturing and marketing costs of the present invention. Furthermore, laypersons should be able to handle the installation and operation of the present invention.

Accordingly, in order to accomplish the above objects, the present invention provides a DVD player system for an auto audio system which comprises at least a speaker having an audio input, comprising:

a DVD loader for reading storing data stored in a DVD and converting the storing data into a digital audio data and a digital video data;

a video system comprising a video display unit electrically connected with the DVD loader to convert the video data into a video signal; and

a wireless audio system, comprising:

an audio signal transmitter electrically connected to the DVD loader to transmit the audio data as an audio frequency signal; and

an audio signal receiver, which is adapted for electrically connecting with the audio input of the speaker, wirelessly communicating with the audio signal transmitter for receiving the audio frequency signal therefrom in a wireless manner, thereby, the audio frequency signal is then converted into an acoustical signal through the speaker.

These and other objectives, features, and advantages of the present invention will become apparent from the following detailed description, the accompanying drawings, and the appended claims.

### BRIEF DESCRIPTION OF THE DRAWINGS

FIG. 1 is a perspective view of a Digital Video Disc (DVD) player system according to a preferred embodiment of the present invention.

FIG. 2 is a schematic flow diagram of the DVD player system according to the above preferred embodiment of the present invention.

FIG. 3 is a block diagram of the DVD player system according to the above preferred embodiment of the present invention.

### DETAILED DESCRIPTION OF THE PREFERRED EMBODIMENTS

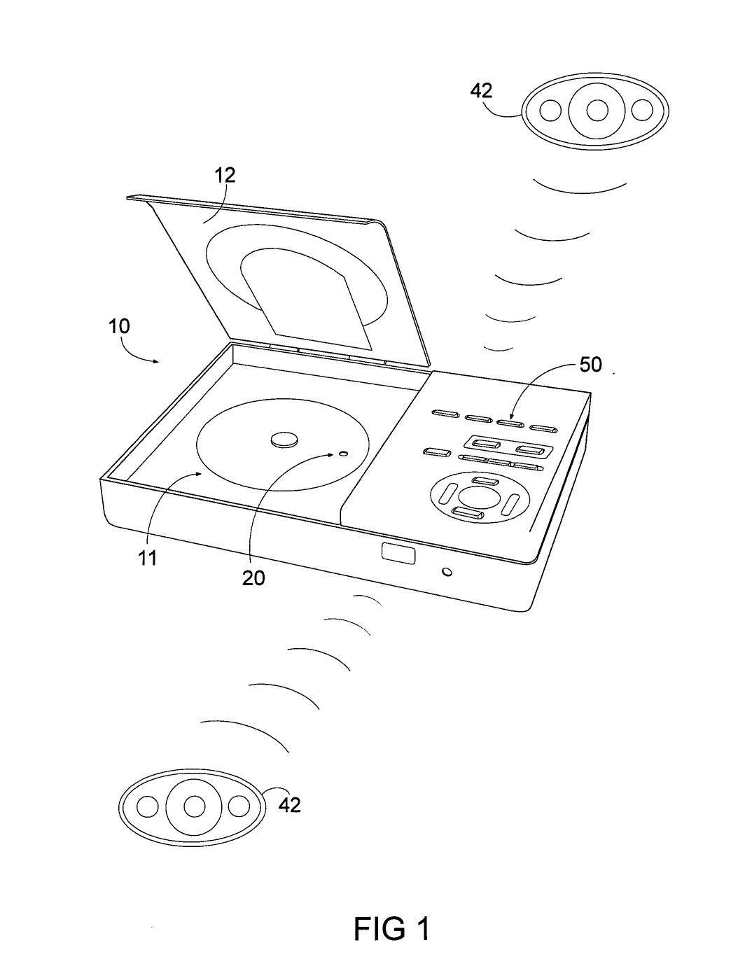

Referring to FIGS. 1 through 3 of the drawings, a Digital Video Disc (DVD) player system for an auto audio system according to a preferred embodiment of the present invention is illustrated. According to the preferred embodiment, the DVD player comprises an outer case 10, a DVD loader 20, a video system 30 and a wireless audio system 40.

The DVD loader 20, which is protected within the outer case 10, is arranged for reading storing data stored in a DVD and converting the storing data into a digital audio data and a digital video data. Accordingly, the DVD loader 20 can be obviously substituted by a disc loader to load the audio/video data stored in a disc.

Referring to FIG. 1 of the drawings, the outer case 10 comprises a retrieving platform 11 formed on a top side of the outer case 10, and a protection cover 12 operatively mounted on top of the retrieving platform 11 for moving between an opened position and a closed position. In which, at the opened position, the protection cover 12 is pivotally and upwardly moved from the top side of the outer case 10 wherein an external signal storage medium, such as the Digital Video Disc (DVD) is adapted to be disposed on the retrieving platform 11, and at the closed position, the protection cover 12 is pivotally moved towards the top side of the outer case 10 so as to completely cover up the retrieving platform 11 so that the DVD loader 20 is capable of loading the storing data in the DVD. Accordingly, the signal retrieval and transmission could only take place via the DVD loader 20 while the protection cover 11 is at the closed position for safety purpose.

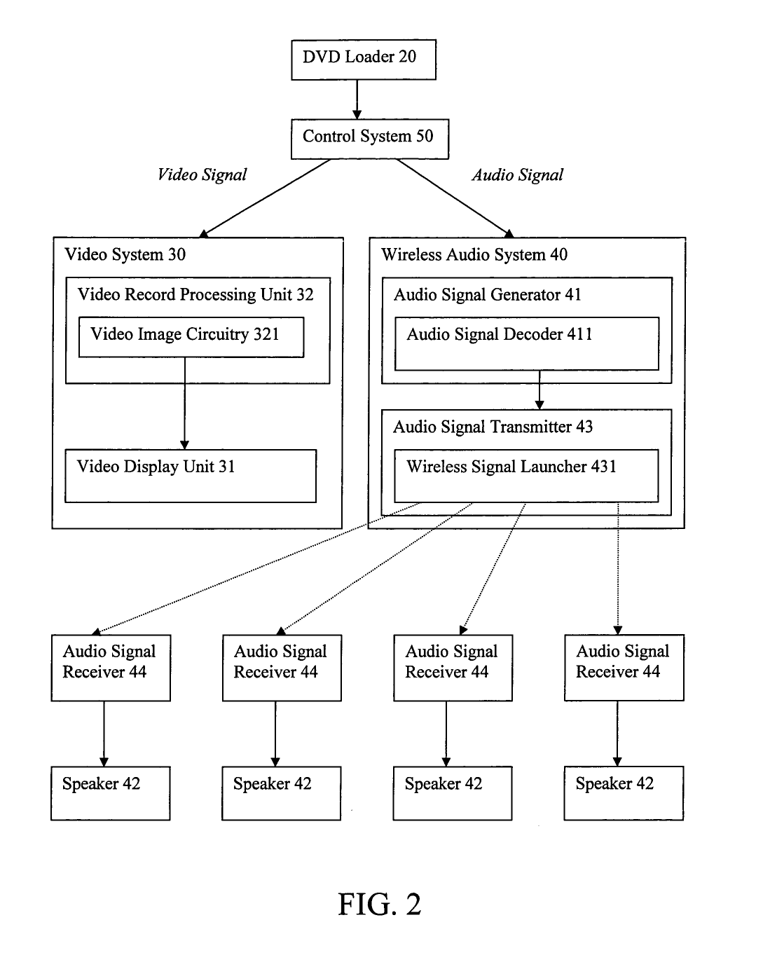

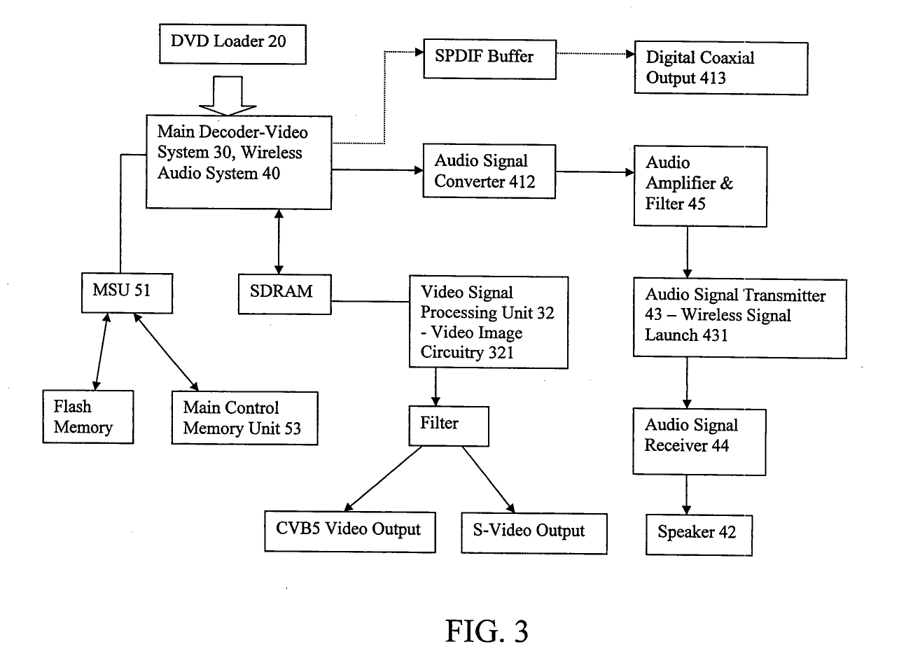

The video system 30 comprises a video display unit 31 which is electrically connected with the DVD loader 20, preferably through a regular video signal wire, and a video record processing unit 32 which is preferably provided in the outer case 10 for processing and transmitting video signal retrieved from the DVD loader 20 to the video display unit 31. Referring to FIG. 2 of the drawings, the video record processing unit 32 comprises video image circuitry 321 optically communicated with the DVD loader 20 in such a manner that the video signal stored in the DVD is retrieved by the video image circuitry 321 which then re-encodes the video signal and transmits the re-encoded video signal to the video display unit 32, preferably via a video signal filter 33, as shown in FIG. 2 and FIG. 3 of the drawings. It is worth mentioning that the video signal can be delivered through a S-video output, or alternatively, a CVBS video output.

The video display unit 32 can be conveniently embodied as a regular television or a computer monitor for displaying video image which is encoded in the DVD loader 20. Moreover, the video image circuitry 321 can be securely welded on a video Integrated Circuit (IC) board which is supported in the outer case 10.

The wireless audio system 40, which is electrically connected to the DVD loader 20, comprises an audio signal generator 41, a speaker 42, an audio signal transmitter 43 and an audio signal receiver 44.

The audio signal generator 41 comprises an audio signal decoder 411 electrically connected to the audio signal transmitter 43 for decoding the audio data from the DVD loader 20 into the audio frequency signal, such that the audio signal transmitter 43 is adapted for wirelessly transmitting the audio frequency signal to the audio signal receiver 44. Accordingly, the audio signal decoder 411 consists an audio signal circuitry adapted to be optically communicated with the DVD loader 20 so as to read and decode the audio signal stored in the DVD into a predetermined set of decoded signal. Note that the decoded signal is preferably in digital form which is then converted into an analogue form by an audio Digital Analogue Converter (DAC) 412. In other words, the audio signal decoder 411 is a digital analogue converter electrically connected to the audio signal transmitter 43 for converting the audio data in digital form into an analogue form with a frequency matching with the audio signal receiver 44.

According to the preferred embodiment, the audio signal circuitry can be implemented onto a regular IC board which is supported in the outer case 10. Hence, the audio signal circuitry and the video image circuitry 321 could be implemented onto one single IC board so as to form a main decoder for the DVD player system of the present invention.

The speaker 42, having an audio input, is preferably embodied as an audio interpreter of the auto audio system which is located distance away from the outer case 10. Thus, the speaker 42 usually comprises a sound generator, such as a vibration membrane, which is subject to vibration in accordance with a predetermined set of acoustical signal so as to produce sound wave of audible frequency. Accordingly, the speaker 42 usually further comprises an acoustical signal transformer which provides acoustical signal to the sound generator.

The audio signal transmitter 43 is electrically connected to the DVD loader 20 to transmit the audio data as an audio frequency signal. The audio signal transmitter 43 is electrically connected with the audio signal generator 41 via an audio amplifier and filter 45 and comprises a wireless signal launcher 431 which is preferably embodied as a Frequency Modulation (FM) stereo transmitter capable of delivering wireless signal with respect to the decoded signal generated by the audio signal decoder 411 at a predetermined range of frequency. In other words, the frequency modulation of the audio signal transmitter 43 is arranged for transmitting the audio frequency signal within a predetermined frequency range so as to wirelessly connect the DVD loader 20 with the speaker 42.

In order to enhance the adaptability of the DVD player of the present invention in differing surrounding circumstances, the FM stereo transmitter is adapted to be selectively tuned so as to deliver decoded signal wirelessly at a particular frequency chosen from a predetermined range of available frequency. As such, the user of the present invention is able to tune the required frequency which is to be delivered at an optimal performance at a particular environment such as in a car.

The audio signal receiver 44 is electrically connected to the audio input of the speaker 42 and is wirelessly communicating with the audio signal transmitter 43 for receiving the audio frequency signal therefrom in a wireless manner. Accordingly, the audio signal receiver 44 is adapted to receive and transform the decoded signal as delivered by the audio signal transmitter 43 at a particular frequency into acoustical signal which is then fed into the acoustical signal transformer of the speaker 42 for sound wave generation. Accordingly, the audio signal receiver 44 is a wireless signal receiving device to wirelessly receive the audio frequency signal from the audio transmitter 43, wherein the audio signal receiver 44 is manually tuned to match with same frequency of the audio signal transmitter 43 to wirelessly communicate with the audio signal transmitter 43. Alternatively, the audio signal receiver 44 can be automatically tuned to match with same frequency of the audio signal transmitter 43 to wirelessly communicate with the audio signal transmitter 43. As a result, depending on the surrounding circumstances in which the DVD player of the present invention operates, the audio signal transmitter 43 and the audio signal receiver 44 are capable of being adjusted to the most suitable frequency for optimal performance.

As an illustration, the discrete selectable frequencies as delivered by the audio signal transmitter 43 can be either 88.7 MHz or 88.5 MHz. The selection of the either frequency solely depends on the quality of the audio signal transmitted at a particular surrounding circumstance and is capable of being adjusted by the user.

Referring to FIG. 3 of the drawings, the DVD player of the present invention further comprises a control system 50 provided in the outer case 10 for controlling DVD loader 20, the video system 30 and the wireless audio system 40. The control unit 50 comprises a Multi-Control Unit (MCU) 51, a control panel 52 provided on the outer case 10 and electrically communicated with the MCU 51, and at least one main control memory unit 53 electrically connected with the MCU 51 for storing operative parameters of the DVD player of the present invention. The MCU 51 comprises a control circuitry which generates control signal which is then to be transmitted to the DVD loader 20, the video system 30 and the wireless audio system 40 for controlling their corresponding operations. The control circuitry is preferably implemented on a control IC board which is separated from the video IC board mentioned above, or alternatively, the control circuitry and the video image circuitry could be implemented on one IC board so as to simplify the internal structure of the DVD player. The commanding programs for the control signal is preferably stored in a 4M Bits flash memory which is electrically communicated with the control circuitry.

The control panel 52 is provided on a top surface of the outer case 10 so that a user of the present invention is able to switch the various operations as he/she desires. As a further enhancement, the control panel 52 may be provided with a remote control unit so that the user could be able to switch the DVD player remotely.

The main control memory unit 53 preferably comprises an Electrically Erasable Programmable Read Only Memory (EEPROM) which is adapted to store the various operative parameters of the DVD player, such as image format, video system properties, audio output format . . . etc. Therefore, the control circuitry is arranged to generate control signal in accordance with the information stored in the main control memory unit 53.

The operation of the DVD player is summed up as follows: a desired DVD is first placed on the retrieving platform 21 and then fed into the wireless audio system 40 and the video system 30 in the outer case 10 for data retrieval via the DVD loader 20. The video signal stored in the DVD is then retrieved and re-encoded by the video signal processing unit 32. The re-encoded video signal is then transmitted to the video display unit 31 through the video signal filter 33.

Similarly, the audio signal stored in the DVD is decoded and converted in the audio signal generator 41 via the DVD loader 20. The converted and decoded signal is then fed into the audio signal transmitter 43, preferably through the audio amplifier and filter 45, wherein the signal is transmitted wirelessly, through an antenna, by the audio signal transmitter 43 to the audio signal receiver 44 at a selected frequency. The wirelessly transmitted signal is then fed into the speaker 42 for sound generation.

Finally, as shown in FIG. 3 of the drawings, the DVD player is adapted to be extended to an external power source, such as a rechargeable battery or through regular AC current socket.

As a further enhancement, the traditional methodology of audio signal transmittal should not be deprived of in order to maximize the flexibility of the present invention. Therefore, as shown in FIG. 3 of the drawings, the decoded audio signal can be, instead of being fed into the signal converter 412, fed into an SPDIF buffer which is further connected to a digital coaxial output 413. In turn, the digital coaxial output 413 is adapted to be connected to a Dolby or DTS loudspeaker for direct Dolby or DTS acoustical interpretation.

One skilled in the art will understand that the embodiment of the present invention as shown in the drawings and described above is exemplary only and not intended to be limiting.

It will thus be seen that the objects of the present invention have been fully and effectively accomplished. It embodiments have been shown and described for the purposes of illustrating the functional and structural principles of the present invention and is subject to change without departure form such principles. Therefore, this invention includes all modifications encompassed within the spirit and scope of the following claims.

What is claimed is:

1. A DVD player system for an auto audio system which comprises a speaker having an audio input, comprising:
a DVD loader for reading storing data stored in a DVD and converting said storing data into a digital audio data and a digital video data;
a video system comprising a video display unit electrically connected with said DVD loader for converting said video data into a video signal; and
a wireless audio system, comprising:
an audio signal transmitter electrically connected to said DVD loader to transmit said audio data as an audio frequency signal; and
an audio signal receiver, which is adapted for electrically connecting with said audio input of the speaker, wirelessly communicating with said audio signal transmitter for receiving said audio frequency signal therefrom in a wireless manner, thereby, said audio frequency signal is then converted into an acoustical signal through said speaker.

2. The DVD player system, as recited in claim 1, wherein said audio signal transmitter comprises a frequency modulation stereo transmitter for transmitting said audio frequency signal within a predetermined frequency range so as to wirelessly connect said DVD loader with said speaker.

3. The DVD player system, as recited in claim 1, wherein said audio signal receiver is a wireless signal receiving device to wirelessly receive said audio frequency signal from said audio transmitter, wherein said audio signal receiver is manually tuned to match with same frequency of said audio signal transmitter to wirelessly communicate with said audio signal transmitter.

4. The DVD player system, as recited in claim 2, wherein said audio signal receiver is a wireless signal receiving device to wirelessly receive said audio frequency signal from said audio transmitter, wherein said audio signal receiver is manually tuned to match with same frequency of said audio signal transmitter to wirelessly communicate with said audio signal transmitter.

5. The DVD player system, as recited in claim 1, wherein said audio signal receiver is a wireless signal receiving device to wirelessly receive said audio frequency signal from said audio transmitter, wherein said audio signal receiver is automatically tuned to match with same frequency of said audio signal transmitter to wirelessly communicate with said audio signal transmitter.

6. The DVD player system, as recited in claim 2, wherein said audio signal receiver is a wireless signal receiving device to wirelessly receive said audio frequency signal from said audio transmitter, wherein said audio signal receiver is automatically tuned to match with same frequency of said audio signal transmitter to wirelessly communicate with said audio signal transmitter.

7. The DVD player system, as recited in claim 1, wherein said wireless audio system further comprises an audio signal decoder electrically connected to said audio signal transmitter for decoding said audio data from said DVD loader into said audio frequency signal, such that said audio signal transmitter is adapted for wirelessly transmitting said audio frequency signal to said audio signal receiver.

8. The DVD player system, as recited in claim 4, wherein said wireless audio system further comprises an audio signal decoder electrically connected to said audio signal transmitter for decoding said audio data from said DVD loader into said audio frequency signal, such that said audio signal transmitter is adapted for wirelessly transmitting said audio frequency signal to said audio signal receiver.

9. The DVD player system, as recited in claim 6, wherein said wireless audio system further comprises an audio signal decoder electrically connected to said audio signal transmitter for decoding said audio data from said DVD loader into said audio frequency signal, such that said audio signal transmitter is adapted for wirelessly transmitting said audio frequency signal to said audio signal receiver.

10. The DVD player system, as recited in claim 7, wherein said audio signal decoder is a digital analogue converter electrically connected to said audio signal transmitter for converting said audio data in digital form into an analogue form with a frequency matching with said audio signal receiver.

11. The DVD player system, as recited in claim 8, wherein said audio signal decoder is a digital analogue converter electrically connected to said audio signal transmitter for converting said audio data in digital form into an analogue form with a frequency matching with said audio signal receiver.

12. The DVD player system, as recited in claim 9, wherein said audio signal decoder is a digital analogue converter electrically connected to said audio signal transmitter for converting said audio data in digital form into an analogue form with a frequency matching with said audio signal receiver.

13. An auto audio system, comprising:
a disc loader for reading storing data stored in a disc and converting said storing data into a digital audio data;
a wireless audio system, comprising:
an audio signal transmitter electrically connected to said disc loader to transmit said audio data as an audio frequency signal; and
an audio signal receiver, which is adapted for electrically connecting with said audio input of the speaker, wirelessly communicating with said audio signal transmitter for receiving said audio frequency signal therefrom in a wireless manner; and
at least a speaker, which is wirelessly communicating with said disc loader through said wireless audio system, having an audio input electrically connected to said audio signal receiver wherein said speaker is capable of converting said audio frequency signal into an acoustical signal when audio signal receiver receives said audio frequency signal.

14. The auto audio system, as recited in claim 13, wherein said audio signal transmitter comprises a frequency modulation stereo transmitter for transmitting said audio frequency signal within a predetermined frequency range, so as to wirelessly connect said disc loader with said speaker.

15. The auto audio system, as recited in claim 13, wherein said audio signal receiver is a wireless signal receiving device to wirelessly receive said audio frequency signal from said audio transmitter, wherein said audio signal receiver is manually tuned to match with same frequency of said audio signal transmitter to wirelessly communicate with said audio signal transmitter.

16. The auto audio system, as recited in claim 14, wherein said audio signal receiver is a wireless signal receiving device to wirelessly receive said audio frequency signal from said audio transmitter, wherein said audio signal receiver is manually tuned to match with same frequency of said audio signal transmitter to wirelessly communicate with said audio signal transmitter.

17. The auto audio system, as recited in claim 13, wherein said audio signal receiver is a wireless signal receiving device to wirelessly receive said audio frequency signal from said audio transmitter, wherein said audio signal receiver is automatically tuned to match with same frequency of said audio signal transmitter to wirelessly communicate with said audio signal transmitter.

18. The auto audio system, as recited in claim 14, wherein said audio signal receiver is a wireless signal receiving device to wirelessly receive said audio frequency signal from said audio transmitter, wherein said audio signal receiver is automatically tuned to match with same frequency of said audio signal transmitter to wirelessly communicate with said audio signal transmitter.

19. The auto audio system, as recited in claim 13, wherein said wireless audio system further comprises an audio signal decoder electrically connected to said audio signal transmitter for decoding said audio data from said disc loader into said audio frequency signal, such that said audio signal transmitter is adapted for wirelessly transmitting said audio frequency signal to said audio signal receiver.

20. The auto audio system, as recited in claim 16, wherein said wireless audio system further comprises an audio signal decoder electrically connected to said audio signal transmitter for decoding said audio data from said disc loader into said audio frequency signal, such that said audio signal transmitter is adapted for wirelessly transmitting said audio frequency signal to said audio signal receiver.

21. The auto audio system, as recited in claim 18, wherein said wireless audio system further comprises an audio signal decoder electrically connected to said audio signal transmitter for decoding said audio data from said disc loader into said audio frequency signal, such that said audio signal transmitter is adapted for wirelessly transmitting said audio frequency signal to said audio signal receiver.

22. The auto audio system, as recited in claim 19, wherein said audio signal decoder is a digital analogue converter electrically connected to said audio signal transmitter for converting said audio data in digital form into an analogue form with a frequency matching with said audio signal receiver.

23. The auto audio system, as recited in claim 20, wherein said audio signal decoder is a digital analogue converter electrically connected to said audio signal transmitter for converting said audio data in digital form into an analogue form with a frequency matching with said audio signal receiver.

24. The auto audio system, as recited in claim 21, wherein said audio signal decoder is a digital analogue converter electrically connected to said audio signal transmitter for converting said audio data in digital form into an analogue form with a frequency matching with said audio signal receiver.
